(19) United States
(12) Patent Application Publication
(10) Pub. No.: US 2026/0329875 A1
(43) Pub. Date: Oct. 22, 2026

(54) APPROXIMATE NEAREST NEIGHBOR SEARCH USING SPILLED ASSIGNMENTS

(71) Applicant: Google LLC, Mountain View, CA (US)

(72) Inventors: Philip Wenjie Sun, New York, NY (US); David M. Simcha, Jersey City, NJ (US); David Thomas Dopson, New York, NY (US); Ruiqi Guo, Jersey City, NJ (US); Sanjiv Kumar, Jericho, NY (US)

(21) Appl. No.: 19/484,747

(22) PCT Filed: May 17, 2024
(86) PCT No.: PCT/US2024/029991

§ 371 Date: Nov. 14, 2025

Related U.S. Application Data
(60) Provisional application No. 63/502,912, filed on May 17, 2023.

(51) Int. Cl. G06F 16/2458; G06F 16/22; G06F 16/2455; G06F 18/2413

(52) U.S. Cl. CPC G06F 16/2462; G06F 16/2237; G06F 16/24556; G06F 18/24147

(57) ABSTRACT

Methods, systems, and apparatus, including computer programs encoded on a computer storage medium, for performing a nearest neighbor search procedure. In one aspect, a method includes receiving a query for one or more nearest neighbor data points to a requested data point from a dataset of multiple data points, maintaining data representing a codebook, where the codebook is associated with a first set and a second set of vector quantization assignments, where the codebook includes multiple centers and each center represents a different partition of the dataset, where the first set of vector quantization assignments assigns each data point to an index of a closest center of the multiple centers and the second set of vector quantization assignments assigns each data point to an index of another center of the plurality of centers, and determining one or more nearest neighbor data points for the query using the data.

### BACKGROUND

This specification relates to performing an approximate nearest neighbor search procedure.

A system can perform an approximate nearest neighbor search procedure by receiving a query for a requested data point and searching for one or more nearest neighbor data points within a set of data points.

### SUMMARY

This specification describes a system implemented as computer programs on one or more computers in one or more locations that performs an approximate nearest neighbor search procedure using multiple vector quantization assignments for multiple data points of a dataset.

The system can receive a query for one or more nearest neighbor data points to a requested data point from the dataset of multiple data points. That is, the query is a request to identify, from the data points in the dataset, the k nearest data points to the data. As used in this specification, nearest neighbor data points are data points that are close in distance to the requested data point.

The system maintains data that represents a codebook. The codebook is associated with a first set of vector quantization assignments and a second set of vector quantization assignments. The codebook includes multiple centers, and each center represents a different partition of the dataset of a plurality of data points. As used in this specification, a center is a centroid corresponding to a partition of the dataset (e.g., a partitioning centroid). That is, a center is a data point that has the same dimensionality as the data points in the data set and represents a centroid of a partition of the data set.

The first set of vector quantization assignments assigns each data point to an index of a closest center of the multiple centers and the second set of vector quantization assignments assigns each data point to an index of another center of the multiple centers. In particular, the system generates the second set of vector quantization assignments by minimizing a loss function that is based on a first partitioning residual for each data point. For example, the loss can be an orthogonality amplified residual loss.

The system then determines one or more nearest neighbor data points for the query using the maintained data.

Particular embodiments of the subject matter described in this specification can be implemented so as to realize one or more of the following advantages.

Conventional systems perform a nearest neighbor search procedure by performing a linear scan of a set of candidate data points from a dataset. A system can perform maximum inner product search of each of the candidate data points, and the system can determine one or more nearest neighbor data points based on the maximum inner product search, which can be computationally expensive and inefficient for large datasets.

Some other systems can perform an approximate nearest neighbor (ANN) search procedure, which allows for improved computational efficiency in scanning datasets with a relatively small loss of accuracy. In particular, ANN search can include performing partitioning of datasets. The system can perform indexing of data points of large datasets using spill trees by assigning each data point to multiple indices corresponding to multiple partitions of the dataset. By assigning the data points to multiple partitions, the system can generate a replicated “spilled” view of the dataset, which reduces the probability of missing (e.g., not determining) a nearest neighbor data point. However, partitioning high-dimensional data is difficult and can lead to decreased accuracy as the size of the dataset increases.

In contrast, the system described leverages vector quantization to perform partitioning of a dataset and to generate multiple vector quantization assignments of the data points in the dataset, which can result in increased efficiency and increased accuracy in performing an approximate nearest neighbor search procedure.

The system generates a codebook of centers by applying vector quantization to the dataset, and the system generates a first set of quantization assignments for each data point. Each data point is assigned to an index of the closest center of a set of centers included in the codebook. The system then calculates a first residual of the first set of vector quantization assignments for each point, and the system uses the first residuals to generate a second set of vector quantization assignments.

In particular, the system can generate the second set of vector quantization assignments by, for each data point, determining a loss minimizing center for the data point. The system can determine the loss minimizing center by minimizing a loss function based on the first partitioning residual and a second partitioning residual.

The loss function is an orthogonality amplified residual loss that measures an expected weighted squared inner product of a given requested data point and a second partitioning residual, where the weight for the squared inner product depends on a cosine of an angle between the given requested data point and first partitioning residual.

For example, the system determines the loss minimizing center for the data point by selecting a center having a minimum adjusted squared distance from the multiple centers of the codebook. In particular, the system calculates a squared distance from each data point calculating a squared distance from the data point to the center, and the system determines a penalty term that penalizes the center for parallelism between (i) the first partitioning residual and (ii) a second partitioning residual that measures a distance between the data point and the center. The system then determines an adjusted squared distance using the squared distance and the penalty term and determines the loss minimizing center for the data point by selecting a center having a minimum adjusted squared distance.

The system can then use both the first partitioning residual and the second partitioning residual to perform a more efficient and accurate approximate nearest neighbor search procedure. In particular, the system determines a candidate set of nearest neighbor data points using the first set of quantization assignments and the second set of quantization assignments, and the system performs the maximum inner product search of each of the data points using the second partitioning residual. The system then outputs one or more nearest neighbor data points based on the maximum inner product search. By using the first partitioning residual and the second partitioning residual to determine the nearest neighbor data points, rather than depending on the query of the requested data point, the system can more accurately determine the one or more nearest neighbor data points by leveraging the multiple partitions of the dataset.

Overall, by assigning each data point to multiple centers corresponding to multiple partitions, the system can efficiently scan large datasets for nearest neighbor data points. Additionally, by performing partitioning using vector quantization, the system described reduces latency associated with scanning large datasets, and the system determines nearest neighbor data points with increased efficiency and accuracy.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a block diagram of an example codebook generation system.

FIG. 3 is a flow diagram of an example process for performing a nearest neighbor search procedure.

FIG. 4 is a diagram of vector quantization assignments for an example data point from a dataset of multiple data points.

FIG. 5 is a diagram of implementing spilled vector quantization assignments for multiple datasets.

FIG. 6 is a diagram of the results of implementing spilled vector quantization assignments.

Like reference numbers and designations in the various drawings indicate like elements.

### DETAILED DESCRIPTION

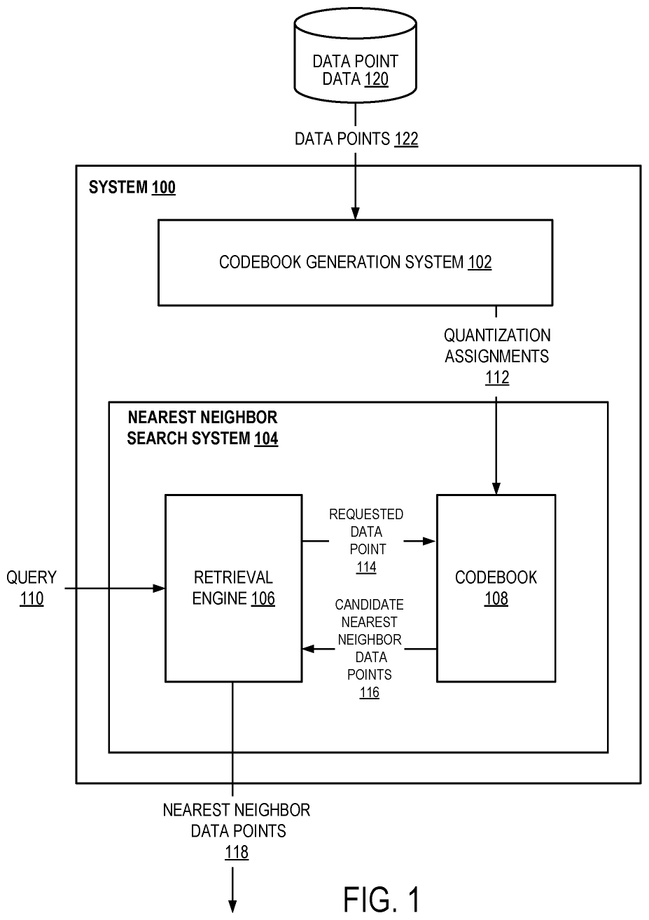

FIG. 1 shows an example system 100. The system 100 is an example of a system implemented as computer programs on one or more computers in one or more locations in which the systems, components, and techniques described below are implemented.

Performing an approximate nearest neighbor (ANN) search has a wide range of applications in machine learning and information retrieval systems. Some examples of this include image search, semantic textual retrieval, anomaly detection, recommendation systems, as well as serving as a component for downstream tasks.

Thus, accurately performing the ANN search can be important to the performance of a variety of machine learning and information retrieval systems. Moreover, given the large number of vectors that need to be searched in many use cases, the ANN search can be computationally expensive and in some cases can bottleneck the computational efficiency of the machine learning or retrieval system. To alleviate these issues, the system 100 performs the ANN search in a computationally efficient manner while still maintaining a high degree of accuracy by generating multiple vector quantization assignments for data points of a dataset in order to effectively search through multiple partitions of the dataset.

Generally, the system 100 is configured to receive a query including a requested data point, and the system 100 is configured to output k nearest neighbor data points based on processing the query using ANN search. K can generally be any positive integer, i.e., any integer greater than or equal to one, but is generally much smaller than the total number of data points in the set. For example, if there are a million data points, the value of k can be less than two thousand and, in some cases, can be less than one hundred or less than fifty.

The system 100 includes a codebook generation system 102 configured to generate and maintain a codebook 108 of the multiple vector quantization assignments and a nearest neighbor search system 104 configured to perform the ANN search procedure by processing the query 110 using the codebook 108.

The codebook generation system 102 can generate vector quantization assignments 112 for each data point of a set of data points 122 from data point data 120. Each data point is assigned to one or more centers of a set of centers that represent a different partition of the set of data points 122.

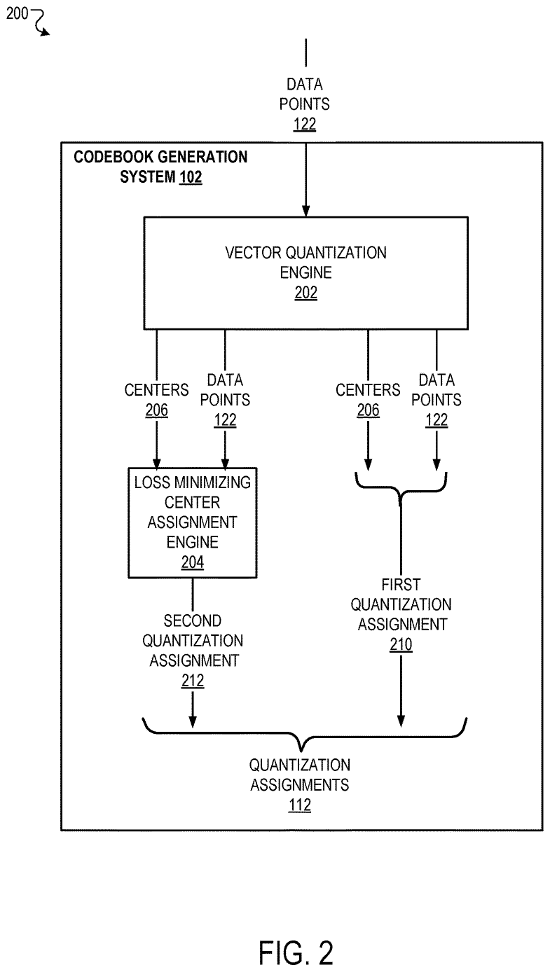

In particular, the vector quantization assignments 112 can include a first set of vector quantization assignments (e.g., non-spilled assignments) based on performing vector quantization of the set of data points 122. In particular, the system can perform vector quantization to generate the first quantization assignments by assigning each data point to a “closest” center. Additionally, based on the first quantization assignments, the system can generate second set of vector quantization assignments (e.g., spilled assignments) by assigning the data point to a “loss-minimizing” center, as described in further detail below with reference to FIGS. 2, 3, and 4. The codebook generation system 102 can provide the quantization assignments 112 to the nearest neighbor search system 104 in order to maintain or update the codebook 108. For example, the codebook generation system 102 can update the codebook 108 based on receiving an updated set of data points.

The nearest neighbor search system 104 can perform the ANN search to generate the nearest neighbor data points 118 by processing the query 110 using the codebook 108. The query 110 can be a query vector provided by a user, and the query vector can include a requested data point 114. In some examples, the requested data point 114 can represent a search request by the user for finding the nearest neighbor data points 118 of the requested data point (e.g., the most relevant search result) of a vector database.

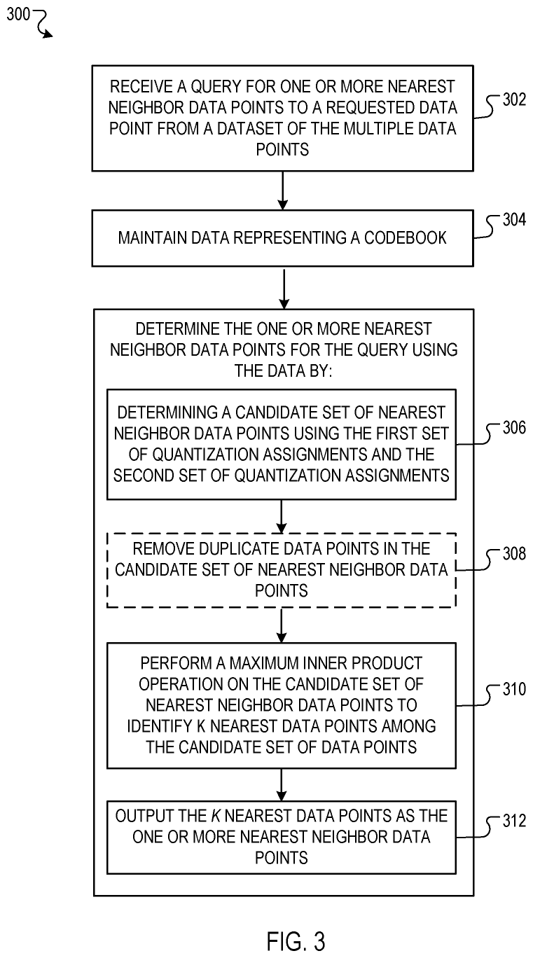

The nearest neighbor search system 104 includes a retrieval engine 106 that is configured to query the codebook 108 for the requested data point 114 and to identify candidate nearest neighbor data points 116 based on the vector quantization assignments 112 stored in the codebook 108. The retrieval engine 106 can identify a candidate set of nearest neighbor data points (e.g., candidate nearest neighbor data points 116) based on searching for centers mapped to the data points by both the first set of vector quantization assignments and the second set of vector quantization assignments, enabling the system to search through the multiple partitions of the data set and to ensure that the set of candidate nearest neighbor data points 116 is relatively extensive. In particular, the retrieval engine 106 can perform an ANN search procedure of the multiple partitions by searching for the closest centers to the requested data point and identifying the candidate nearest neighbor data points 116 based on the vector quantization assignments, as described in further detail below with reference to FIG. 3. By identifying the candidate nearest neighbor data points 116, the system can increase the accuracy and the efficiency of the search by searching over a smaller set of data points than the entirety of the set of data points 122 while using the multiple vector quantization assignments to search through the different partitions of the dataset.

Additionally, by identifying the candidate nearest neighbor data points 116 using the multiple vector quantization assignments, the system 100 is given a “second chance” to accurately output the k nearest neighbor data points by leveraging the multiple partitions of the dataset. For example, in the case where the dataset is relatively large, conventional techniques such as performing vector quantization (e.g. generating the first vector assignments and mapping to the closest center) are not efficient in searching for data points through multiple partitions of the large dataset. In this case, by generating the second vector assignments and mapping to the loss minimizing center, the system can more efficiently search through multiple partitions of the large dataset by finding nearest neighbors that the first vector assignments may have missed.

The nearest neighbor search system 104 can then perform the ANN search procedure using the candidate nearest neighbor data points 116 to determine the nearest neighbor data points 118 based on a similarity metric of the ANN search procedure. In some examples, the nearest neighbor search system 104 can perform a maximum inner product search of each of the candidate data points, as described in more detail below with reference to FIG. 3. In this case, the system determines the nearest neighbor data points 118 by identifying the data points that have the largest similarity measure with the requested data point. In some other examples, the nearest neighbor search system 104 can perform the ANN search using another appropriate similarity measure, e.g., Euclidean distance or other distance measures, where the nearest neighbor data points 118 are those that have the smallest similarity measure with the requested data point 114. By performing the ANN search of the candidate set of data points, the system can increase the efficiency of the search, as the system can search over a smaller set of data points than the entirety of the set of data points 122.

The system 100 can then output the nearest neighbor data points 118 based on performing the ANN search on the candidate nearest neighbor data points 116. In some cases, the system 100 provides the k nearest neighbors as output. In some other cases, the system 100 provides data identifying the k nearest neighbors as output (e.g., by providing the indices of the k nearest neighbors within the set of data points 122).

FIG. 2 is a block diagram of an example codebook generation system, e.g., the codebook generation system 102 described with reference to FIG. 1.

In general, prior to receiving the query, the system generates and updates the codebook 108 by generating the quantization assignments 112 for each of the data points 122.

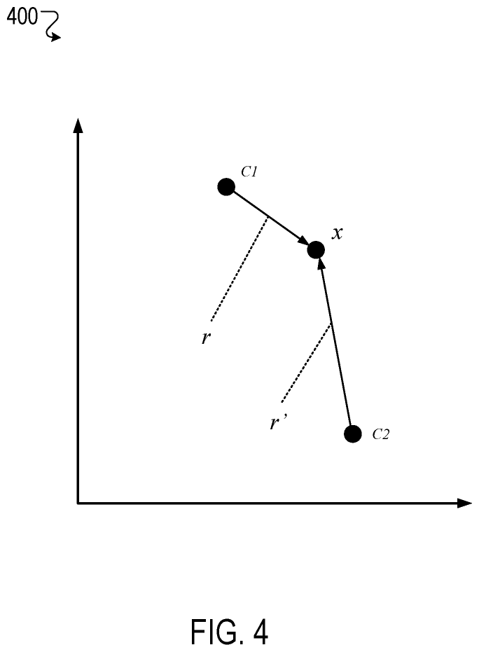

The system includes a vector quantization engine 202 configured to apply vector quantization to the set of data points 122 to generate the first vector quantization assignments, and a loss minimizing center assignment engine 204 configured to generate the second quantization assignments using the first vector quantization assignments. For each data point, the first vector quantization assignment 210 assigns the data point to a “closest” center, and the second vector quantization assignment 212 assigns the data point to a “loss minimizing” center. The closest center is defined as a center from the set of centers that is at the minimal squared distance from the data point, and the loss minimizing center is defined as a center from the set of centers that is at a minimal distance from the data point based on minimizing a loss function, as described in further detail below with reference to FIG. 4.

To generate the vector quantization assignments, the system obtains the set of data points 122 from the data point data 120. Each data point has a respective index (e.g., a respective identifier that uniquely identifies the data point within the set of data points 122).

The system uses the vector quantization engine 202 to generate the first vector quantization assignment 210 for the codebook 108 by applying vector quantization to each of the data points. Each first vector quantization assignment 210 includes a mapping of each data point to a center 206 of multiple centers 206. In particular, the vector quantization engine 202 partitions the data points 122 into multiple partitions based on their respective indices, where each partition corresponds to a center 206. Based on the first vector quantization assignments 210, each partition is made up of a subset of data points 122 with consecutive indices that are mapped to an index of a corresponding center 206.

In particular, by performing vector quantization, the system generates each first vector quantization “non-spilled” assignment 210 by mapping a data point to an index of a center that is the closest center to the data point based on a squared distance between the data point and the center, as shown by Equation 1:

$$π ( x ) = arg min {‖ x - {C}_{i} ‖}_{i ∈ [ 1 , … , c \}}^{2} \qquad ( 1 )$$

where x is the data point, π(v) is the first vector assignment, and Cᵢ is the assigned center with a corresponding index. In some examples, the vector quantization engine 202 can use another appropriate metric to assign the data point to a center in order to generate the first vector quantization assignments 210.

The system provides the data points 122 and the centers 208 of the first vector quantization assignments 210 to the loss minimizing center assignment engine 204 to generate the second vector quantization “spilled” assignments 212. The spilled assignments are referred to as spilled because the assignments 212 assign data points to indices corresponding to centers of multiple partitions of the dataset, thus generating a “spilled” view of the dataset. The loss minimizing center assignment engine 204 assigns each data point to a “loss minimizing” center from the centers 206 by performing a spilled assignment. In particular, the system determines the loss minimizing center by minimizing a loss function based on a first partitioning residual that measures a distance between the data point and the closest center assigned by the first vector quantization assignment, as described in further detail below with reference to FIG. 4.

The system then populates and/or updates the codebook 108 with the first quantization assignment and the second quantization assignment for each data point. The system can use the vector quantization assignments to more accurately retrieve the k nearest neighbors for the requested data point by searching more completely through the multiple partitions of the dataset, as described in more detail below with reference to FIG. 3.

FIG. 3 is a flow diagram of an example process for performing a nearest neighbor search procedure. For convenience, the process 300 will be described as being performed by a system. For example, a system, e.g., the nearest neighbor search system 104 of FIG. 1, appropriately configured in accordance with this specification, can perform the process 300.

The system receives a query for one or more nearest neighbor data points to a requested data point from a dataset of multiple data points (302). For example, the system can receive the query for a user that is querying a vector database.

The system maintains data representing a codebook (304). The codebook includes a first set of vector quantization assignments and a second set of vector quantization assignments. In particular, each vector quantization assignment maps a data point of a dataset to a center, where each center represents a different partition of the dataset of multiple data points.

The first set of vector quantization assignments are non-spilled assignments that assign a data point to a center based on a distance (e.g., a squared distance) between the data point and the center. The second set of vector quantization assignments are spilled assignments that assign a data point to a center based on minimizing a loss function. In general, the first vector quantization assignments assign each data point to an index of a closest center from the multiple centers, and the second vector quantization assignments assign each data point to an index of another center. For each data point, the codebook identifies whether the data point is assigned to the corresponding center by the first vector quantization assignments or the second vector quantization assignments.

The system determines the one or more nearest neighbor data points for the query by identifying a candidate set of nearest neighbor data points using the first set of quantization assignments and the second set of quantization assignments (306). In particular, the system determines the candidate set of nearest neighbor data points by performing an ANN search of the multiple centers that each represent the multiple partitions of the dataset. For example, the system can perform a maximum inner product search operation on the centers to identify one or more k′ centers that are nearest to the requested data point, as shown by Equation 2:

MIPS_{k′}(q,C)=k′argmax [symbol] q,c [symbol] _{c∈C} (2)

where c is a center of the set of centers C and k′ argmax returns the k′ centers among C that have the highest inner product with q. The system can then identify that data points that are assigned to each of the identified centers based on both of the vector quantization assignments. In particular, the system can identify the data points by mapping the centers of the first quantization assignments and the second quantization assignments to the respective data points.

In some examples, the system removes duplicate data points in the candidate set of nearest neighbor data points (308). In particular, because the system can assign a data point to multiple partitions of the dataset based on the multiple vector quantization assignments, two partitions containing the same point can be included in the k′ partitions. In this case, the system can de-duplicate the data point from the candidate set. Advantageously, by de-duplicating the data point, the system can increase the overall efficiency of performing the ANN search by not having to search through the partitions for the duplicate data points.

The system then performs a maximum inner product operation on the candidate set of nearest neighbor data points to identify k nearest neighbor data points among the candidate set of data points (310). In particular, the system performs the maximum inner product search (MIPS) by maximizing the inner product between the requested datapoint q and the candidate set of data points X, as shown by Equation 3:

MIPSₖ(q,X)=kargmax [symbol] q,x [symbol] _{x∈X} (3)

where x is a candidate data point of the dataset X. Based on performing the ANN search, the system can identify the k nearest neighbor data points for the requested data point of the query.

The system outputs the k nearest neighbor data points as the one or more nearest neighbor data points (312). For example, the k nearest neighbor data points can represent the top k results for the user query of the vector database.

FIG. 4 is a diagram of generating vector quantization assignments for an example data point from a dataset of multiple data points.

For each data point x, the system performs a vector quantization procedure to generate a first vector quantization assignment and a second vector quantization assignment. The system generates the first vector quantization assignment by determining a closest center C1 to the data point x using a squared distance between the data point and each center, as described above.

The system then generates the second vector quantization assignment using the first vector quantization assignment by calculating a first partitioning residual r in order to minimize a loss function. In particular, the first partitioning residual r measures a distance between the data point x and the closest center C1, as shown by Equation 4:

r=∥x−Cᵢ∥ (4)

The system then minimizes the loss function. In particular, the loss function can be orthogonality amplified residual loss that measures an expected squared inner product between a requested data point q of a set of queries Q and a second partitioning residual r′, as shown by Equation 5:

L(r′,r,Q)=E_{q∈Q}[w(cos θ) [symbol] q,r′ [symbol] ²] (5)

where the second partitioning residual r′ measures the distance between the requested data point q and the loss minimizing center C2, w is a weighted value, and θ is the angle between the data point x and the first partitioning residual r. The loss function measures the expected squared inner product between the requested data point q and a weighted second partitioning residual r′.

The system then determines the loss minimizing center by, for each center, calculating an adjusted distance by using a squared distance between the data point and the center, as shown by the simplification of the loss function of Equation 6:

L(r′,r,Q)∝∥r′∥²+λ∥projᵣr′∥² (6)

where λ is a penalty term. In particular, the penalty term penalizes the center for parallelism between the first partitioning residual r and the second partitioning residual r′. Thus, the system encourages the partitioning residuals to be orthogonal using the penalty term in order to prioritize quantization performance when the original assignment (e.g., the first vector quantization assignment) performs relatively poorly. The system selects the loss minimizing center C2 by selecting the center with a minimum adjusted squared distance, and the system generates the second quantization assignment by assigning the data point x to the index of the loss minimizing center C2.

By minimizing the loss function, the system can effectively assign a datapoint to multiple partitions of the dataset and recover the nearest neighbor in cases where the original vector quantization assignments (e.g., the first vector quantization assignments) are not accurate in mapping a data point to a nearest center. Thus, assigning the datapoint to multiple partitions allows for completeness and increased accuracy in performing the ANN search.

While this specification generally describes making use of a spilled vector assignment where each point is assigned to two partitions, more generally, the described techniques can be used to assign each point to more than two partitions. In this case, each subsequent assignment can be done as described above, but with a loss considering the distribution of quantized score errors from all prior assignments.

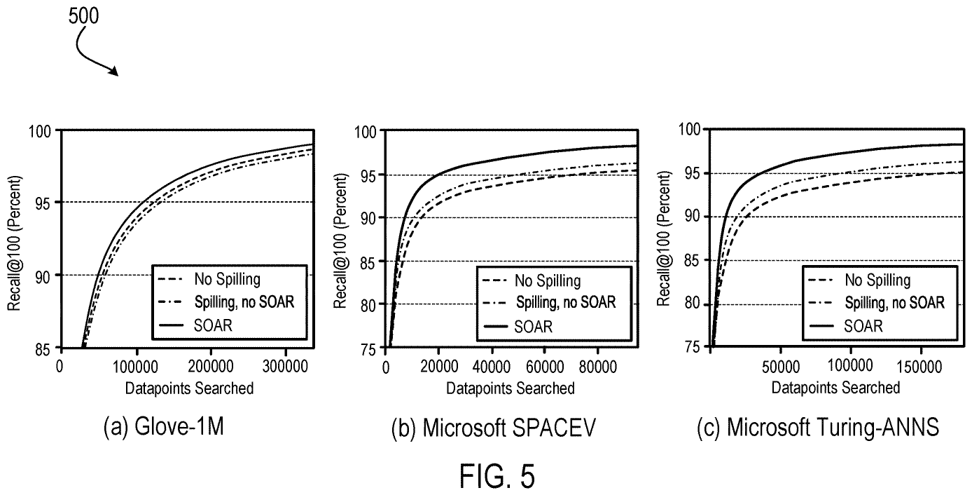

FIG. 5 is a diagram of implementing spilled vector quantization assignments for multiple datasets.

FIGS. 5A-5C are graphs that illustrate the performance of the described technique using a k-means recall (KMR) curve metric. The KMR curve metric measures a performance of the system in determining the k nearest neighbors for a query relative to how many data points are searched as part of the search, i.e., how many candidate data points are searched.

FIG. 5A corresponds to the dataset Glove-1M which includes approximately a million data points. FIG. 5B and FIG. 5C correspond to the relatively larger datasets Microsoft SPACEV and Microsoft Turing-ANNS, respectively, which include over approximately a billion data points.

In particular, SOAR refers to the techniques described of generating first “non-spilled” vector quantization assignments and second “spilled” vector quantization assignments for the dataset. “No spilling” refers to the system only generating the non-spilled quantization assignments. “Spilling, no SOAR” refers to searching using spill trees. As shown in FIGS. 5A-5C, using both of the vector quantization assignments allow the indices of vector quantization assignments to achieve a given recall target while searching through fewer partitions and utilizing less memory bandwidth, increasing ANN search performance.

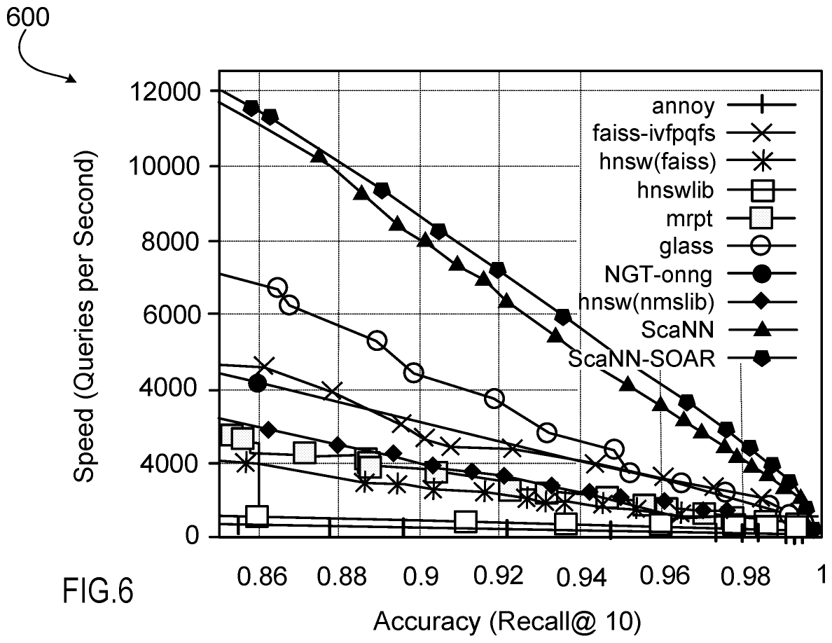

FIG. 6 is a diagram of the results of implementing spilled vector quantization assignments as described in this specification.

The graph of FIG. 6 illustrates the performance of multiple ANN search algorithms based on a search accuracy (e.g., recall) and speed measured by queries-per-second throughput using the Glove-1M dataset.

In particular, the graph shows the performance of a pre-existing ANN search procedure, ScaNN, which also performs maximum inner product search, and a ScaNN procedure that implements the described techniques (ScaNN-SOAR). As shown, the ScaNN-SOAR technique performs the search more accurately at higher speeds than the existing ScaNN technique and much faster than other existing ANN techniques, including the mobile robot programming toolkit (“mrpt”) library and the hierarchical navigable small world library (“hnsw”).

Thus, by implementing the described techniques along with a high performing pre-existing ANN search algorithm, the system can perform a more accurate and faster search of the nearest neighbor data points in comparison with other conventional techniques.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files. e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for performing a nearest neighbor search procedure, the method comprising:
receiving a query for one or more nearest neighbor data points to a requested data point from a dataset of a plurality of data points;
maintaining data representing a codebook, wherein the codebook is associated with a first set of vector quantization assignments and a second set of vector quantization assignments, wherein the codebook comprises a plurality of centers and each center represents a different partition of the dataset of a plurality of data points, wherein the first set of vector quantization assignments assigns each data point to an index of a closest center of the plurality of centers and the second set of vector quantization assignments assigns each data point to an index of another center of the plurality of centers; and
determining one or more nearest neighbor data points for the query using the data.

2. The method of claim 1, further comprising:
generating the codebook of centers by applying vector quantization to the dataset of the plurality of data points; and
for each data point of the dataset of the plurality of data points, generating the vector quantization assignment of the first set of quantization assignments for the data point, wherein the data point is assigned to an index of a closest center of the plurality of centers for the codebook.

3. The method of claim 2, further comprising generating the second set of vector quantization assignments by, for each data point of the dataset:
calculating a first partitioning residual that measures a distance between the data point and the closest center assigned to the data point by the first set of vector quantization assignments;
determining, from the plurality of centers for the codebook, a loss minimizing center for the data point by minimizing a loss function that is based on the first partitioning residual for the data point; and
assigning the data point to an index of the loss minimizing center.

4. The method of claim 3, wherein the loss function is an orthogonality amplified residual loss based on the first partitioning residual.

5. The method of claim 4, wherein the orthogonality amplified residual loss measures an expected squared inner product between the requested data point and a second partitioning residual, wherein the second partitioning residual is weighted by a value based on a cosine of an angle between the requested data point and the first partitioning residual.

6. The method of claim 3, wherein determining the loss minimizing center for the data point further comprises:
for each center of the plurality of centers:
calculating a squared distance from the data point to the center;
determining a penalty term that penalizes the center for parallelism between (i) the first partitioning residual and (ii) a second partitioning residual that measures a distance between the data point and the center; and
determining an adjusted squared distance using the squared distance and the penalty term; and
determining the loss minimizing center for the data point by selecting a center having a minimum adjusted squared distance.

7. The method of claim 1, wherein determining the one or more nearest neighbor data points for the query using the data further comprises:
determining a candidate set of nearest neighbor data points using the first set of quantization assignments and the second set of quantization assignments;
performing a maximum inner product operation on the candidate set of nearest neighbor data points to identify k nearest data points among the candidate set of data points; and
outputting the k nearest data points as the one or more nearest neighbor data points.

8. The method of claim 7, further comprising:
prior to performing the maximum inner product operation, removing duplicate data points in the candidate set of nearest neighbor data points.

9. The method of claim 7, wherein the maintained data identifies, for each center, each data point assigned to the center by the first set of assignments and each data point assigned to the center by the second set of assignments, and wherein determining a candidate set of nearest neighbor data points using the first set of quantization assignments and the second set of quantization assignments comprises:
performing a maximum inner product operation on the plurality of centers to identify one or more centers that are nearest to the requested data point; and
identifying, as the candidate set of nearest neighbor data points, the data points assigned to each of the one or more identified centers by the first set of assignments and by the second set of assignments.

10. The method of claim 1, wherein the first set of vector quantization assignments are non-spilled assignments, and wherein the second set of vector quantization assignments are spilled assignments.

11. A system comprising:
one or more computers; and
one or more storage devices communicatively coupled to the one or more computers, wherein the one or more storage devices store instructions that, when executed by the one or more computers, cause the one or more computers to perform operations comprising:
receiving a query for one or more nearest neighbor data points to a requested data point from a dataset of a plurality of data points;
maintaining data representing a codebook, wherein the codebook is associated with a first set of vector quantization assignments and a second set of vector quantization assignments, wherein the codebook comprises a plurality of centers and each center represents a different partition of the dataset of a plurality of data points, wherein the first set of vector quantization assignments assigns each data point to an index of a closest center of the plurality of centers and the second set of vector quantization assignments assigns each data point to an index of another center of the plurality of centers; and
determining one or more nearest neighbor data points for the query using the data.

12. The system of claim 11, wherein the operations further comprise:
generating the codebook of centers by applying vector quantization to the dataset of the plurality of data points; and
for each data point of the dataset of the plurality of data points, generating the vector quantization assignment of the first set of quantization assignments for the data point, wherein the data point is assigned to an index of a closest center of the plurality of centers for the codebook.

13. The system of claim 12, further comprising generating the second set of vector quantization assignments by, for each data point of the dataset:
calculating a first partitioning residual that measures a distance between the data point and the closest center assigned to the data point by the first set of vector quantization assignments;
determining, from the plurality of centers for the codebook, a loss minimizing center for the data point by minimizing a loss function that is based on the first partitioning residual for the data point; and
assigning the data point to an index of the loss minimizing center.

14. The system of claim 13, wherein the loss function is an orthogonality amplified residual loss based on the first partitioning residual.

15. The method of claim 14, wherein the orthogonality amplified residual loss measures an expected squared inner product between the requested data point and a second partitioning residual, wherein the second partitioning residual is weighted by a value based on a cosine of an angle between the requested data point and the first partitioning residual.

16. One or more non-transitory computer storage media storing instructions that when executed by one or more computers cause the one or more computers to perform operations comprising:
receiving a query for one or more nearest neighbor data points to a requested data point from a dataset of a plurality of data points;
maintaining data representing a codebook, wherein the codebook is associated with a first set of vector quantization assignments and a second set of vector quantization assignments, wherein the codebook comprises a plurality of centers and each center represents a different partition of the dataset of a plurality of data points, wherein the first set of vector quantization assignments assigns each data point to an index of a closest center of the plurality of centers and the second set of vector quantization assignments assigns each data point to an index of another center of the plurality of centers; and
determining one or more nearest neighbor data points for the query using the data.

17. The one or more non-transitory media of claim 16, wherein the operations further comprise:
generating the codebook of centers by applying vector quantization to the dataset of the plurality of data points; and
for each data point of the dataset of the plurality of data points, generating the vector quantization assignment of the first set of quantization assignments for the data point, wherein the data point is assigned to an index of a closest center of the plurality of centers for the codebook.

18. The one or more non-transitory media of claim 17, further comprising generating the second set of vector quantization assignments by, for each data point of the dataset:
calculating a first partitioning residual that measures a distance between the data point and the closest center assigned to the data point by the first set of vector quantization assignments;
determining, from the plurality of centers for the codebook, a loss minimizing center for the data point by minimizing a loss function that is based on the first partitioning residual for the data point; and
assigning the data point to an index of the loss minimizing center.

19. The one or more non-transitory media of claim 18, wherein the loss function is an orthogonality amplified residual loss based on the first partitioning residual.

20. The one or more non-transitory media of claim 19, wherein the orthogonality amplified residual loss measures an expected squared inner product between the requested data point and a second partitioning residual, wherein the second partitioning residual is weighted by a value based on a cosine of an angle between the requested data point and the first partitioning residual.
